(19) United States
(12) Patent Application Publication
(10) Pub. No.: US 2024/0400193 A1
(43) Pub. Date: Dec. 5, 2024

(54) TRACK ASSEMBLY

(71) Applicant: Pexco Aerospace, Inc., Union Gap, WA (US)

(72) Inventors: John Ponce, Union Gap, WA (US); Fernando Coronel, Union Gap, WA (US); Chris Howard, Union Gap, WA (US)

(21) Appl. No.: 18/731,834

(22) Filed: Jun. 3, 2024

Related U.S. Application Data
(60) Provisional application No. 63/505,861, filed on Jun. 2, 2023.

(51) Int. Cl. B64C 9/02; B64C 9/14

(52) U.S. Cl. CPC B64C 9/02; B64C 9/14

(57) ABSTRACT

A track assembly for routing wires in an aircraft is provided including a retainer configured to be coupled to a track or frame in the aircraft, the retainer having a first wall, a second wall, a first flange projecting inward from the first wall, a second flange projecting inward from the second wall, a first catch extending outward from a first side, and a second catch extending outward from a second side, wherein the retainer define a passageway for wires, and a cover having a first arm projecting from a bottom surface and having a first hook for engaging the first catch, and a second arm projecting from the bottom surface and having a second hook for engaging the second catch, wherein the cover is configured to be removably coupled to the retainer.

### RELATED APPLICATION DATA

This application claims the benefit of U.S. Provisional Patent Application No. 63/505,861 filed Jun. 2, 2023, which is hereby incorporated herein by reference.

### FIELD OF INVENTION

The present application relates generally to a track assembly, and more particularly to a track assembly for an aircraft.

### BACKGROUND

Wiring raceways in airplanes are channels or pathways designed to securely contain and protect electrical wiring and cables throughout the aircraft. The raceways are strategically routed throughout the aircraft to accommodate a complex network of electrical systems. Raceways protect the wiring and cables from various environmental factors and potential hazards within the aircraft. This includes protecting the wiring and wiring harnesses from mechanical damage, abrasion, vibration, moisture, and electromagnetic interference. The raceways may be integrated into the overall aircraft structure and interior design to ensure functionality and aesthetics. For instance, they may run along structural elements such as frames, ribs, and bulkheads or they may be concealed within interior panels and compartments.

Raceway design and installation must comply with aerospace regulations and standards to ensure the safety and airworthiness of the aircraft. These regulations cover aspects such as materials, construction, electrical insulation, and testing procedures. Generally, raceways are made from lightweight and durable materials like aluminum alloys, composite materials, polymers, or plastics.

### SUMMARY

In accordance with an aspect of the present application, a track assembly for routing wires is disclosed. The track assembly includes a retainer and a cover. The retainer may be configured to be coupled to a track or frame in an aircraft. The retainer has a top, a bottom, a first wall, and a second wall that defines a passageway for receiving wires. The top of the retainer has a first catch extending outwardly at the first wall and a second catch extending outwardly at the second wall. The cover may have a top surface and a bottom surface. A first arm projects downwardly from the bottom surface at a first side of the cap. A second arm projects downwardly from the bottom surface at a second side of the cap. The first arm has a hook extending inwardly at an end of the arm that is configured to engage the first catch of the retainer. The second arm has a hook extending inwardly that is configured to engage the second catch of the retainer. The cover can be removably attached to the retainer by the engagement of the first hook with the first catch and by the engagement of the second hook with the second catch.

### BRIEF DESCRIPTION OF THE DRAWINGS

FIG. 1 is a top perspective view of an exemplary track assembly.

FIG. 2 is an exploded front view of the exemplary track assembly.

FIG. 3 is a top perspective view of an exemplary assembled raceway.

FIG. 4 is an exploded top perspective view of an exemplary assembled raceway.

FIG. 5 is a front view of the exemplary assembled raceway.

FIG. 6 is a rear view of the exemplary assembled raceway.

FIG. 7 is a left side view of the exemplary assembled raceway.

FIG. 8 is a right side view of the exemplary assembled raceway.

FIG. 9 is a top view of the exemplary assembled raceway.

FIG. 10 is a bottom view of an exemplary assembled raceway.

FIG. 11 is an exploded front view of the exemplary raceway.

### DETAILED DESCRIPTION

Embodiments of the application relate to a track assembly for routing wires, for example in aircrafts, although it will be appreciated that the assembly may be applicable for wire routing in any suitable vehicle or structure. Existing solutions route wires through single-piece raceways that are fastened to aluminum tracks in the floor of the plane. These single-piece raceways include a passageway configured to accept wiring and a top surface that is disposed slightly above or in line with the floor. The top surface of the single-piece raceway may become damaged or worn out. In order to repair this damage, the entire raceway and wires is removed and replaced.

The disclosed track assembly provides a wire routing solution that minimizes weight, is easier and less costly to repair, and is easier and less costly to manufacture. The track assembly includes a raceway cover that is removably attached to a raceway retainer. The cover can be removed and replaced from the retainer if it is damaged without having to remove and replace the retainer and the wires contained in the retainer.

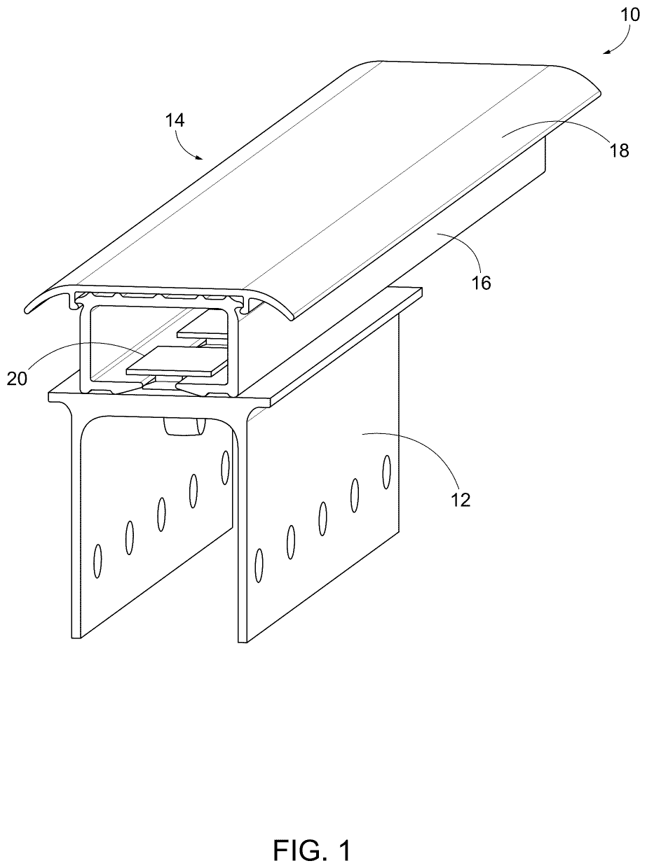

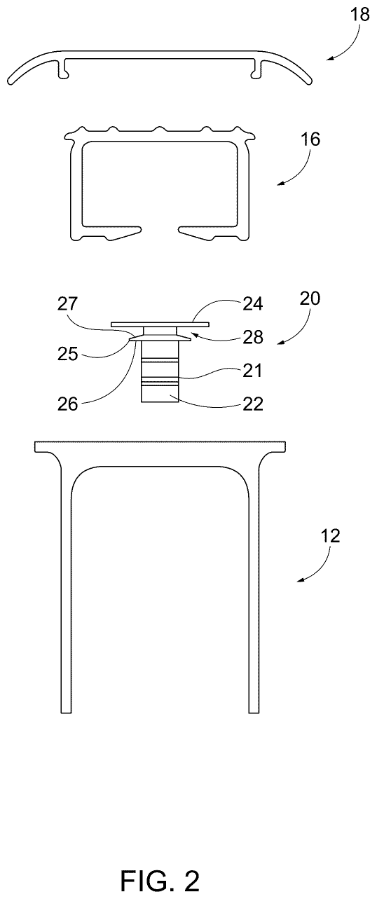

Turning now to FIGS. 1 and 2, an exemplary track assembly is illustrated at reference numeral 10. The track assembly 10 includes a track 12 and a raceway assembly 14 that is configured to be coupled to the track 12 by a plurality of fasteners 20. The track 12 may be made of a suitable material, such as aluminum, and disposed in the floor of an aircraft. The track 12 may be mechanically coupled or integrally formed with the frame of the aircraft. The raceway assembly 14 may include a retainer 16 and a cover 18 that is configured to be removably coupled to the retainer 16. For instance, the cover 18 may be removably coupled to the retainer 16 through a snap fit connection. The retainer 16 may be coupled to the track 12 by the plurality of fasteners 20, which each have a body 21 with a first end 22 and a second end 24 opposite the first end 22 that is a top flange. A projection 25 having a bottom and top surface 26 and 27 extends outwardly from the body of the fastener 20 between the first end 22 and the second end 24. A groove 28 configured to slidably receive the retainer 16 is defined by a space between the top surface 27 of the projection 25 and the second end 24. To couple the raceway assembly 14 to the track 12, the retainer 16 is configured to receive the top flange 24 of each of the plurality of fasteners 20 as shown in FIG. 1, and the track 12 is configured to receive the first ends 22 of each of the plurality of fasteners 20 until the bottom surface 26 of the fastener 20 abuts the track 12 and tabs at the first ends 22 of the fasteners 20 are retained in the track 12.

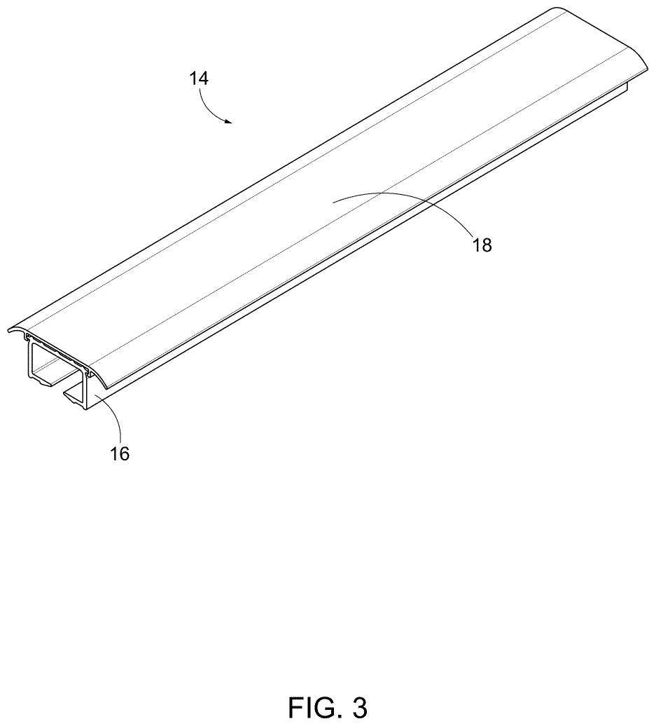

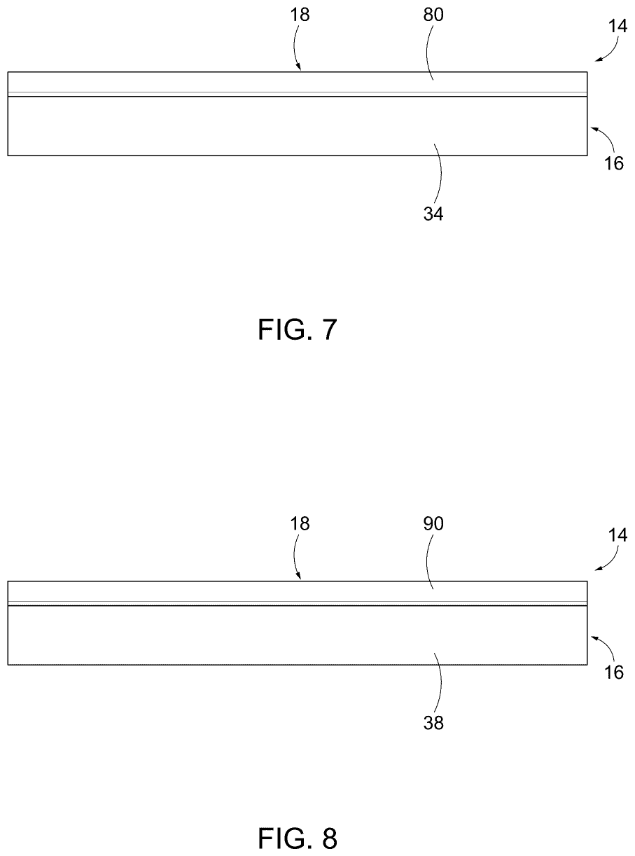

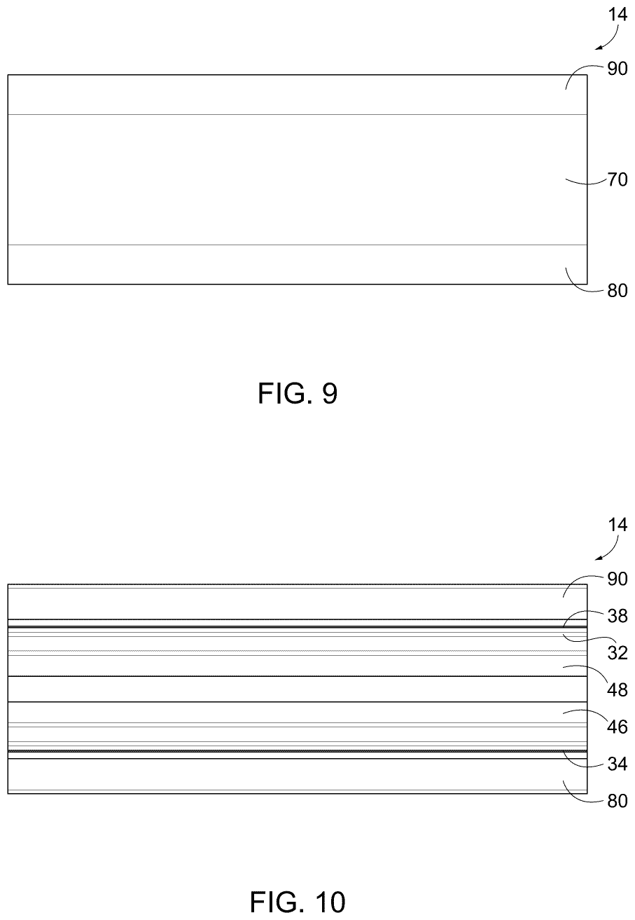

Turning additionally to FIGS. 3-11, the raceway assembly 14 and its components will be described in more detail. The retainer 16 has a substantially rectangular profile with a top 30, a bottom 32, a first wall 34 or first leg extending downward from the top 30 and defining a first side 36, and a second wall 38 or second leg extending downward from the top 30 opposite the first wall 34 and defining a second side 40. A first flange 46 projects inward from the first wall 34 along a length of the first wall 34, and a second flange 48 projects inward from the second wall 38 along a length of the second wall 38 defining the bottom 32. The top 30, bottom 32, first wall 34, and second wall 38 define a passageway 42 for routing wires or cables that extends the length of the retainer 16.

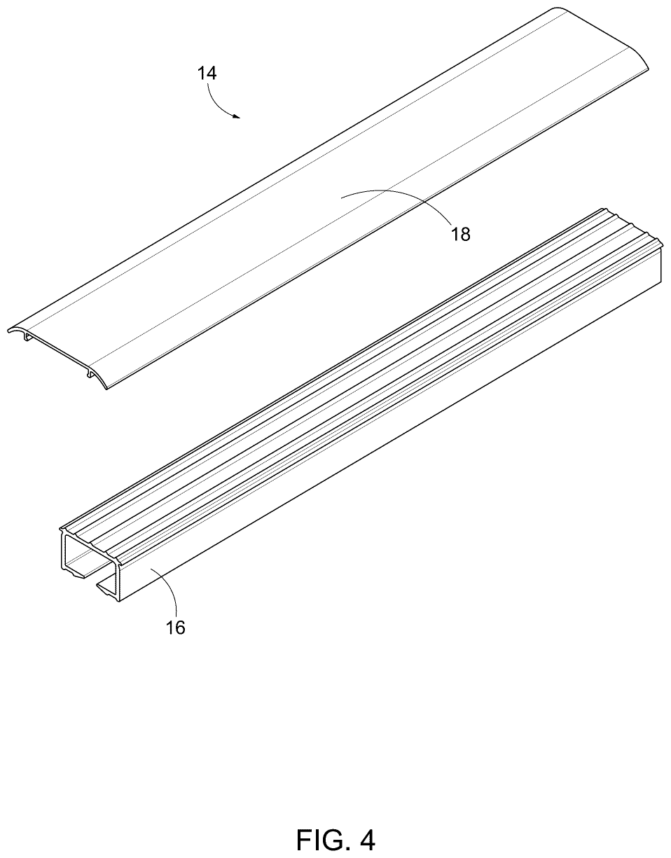

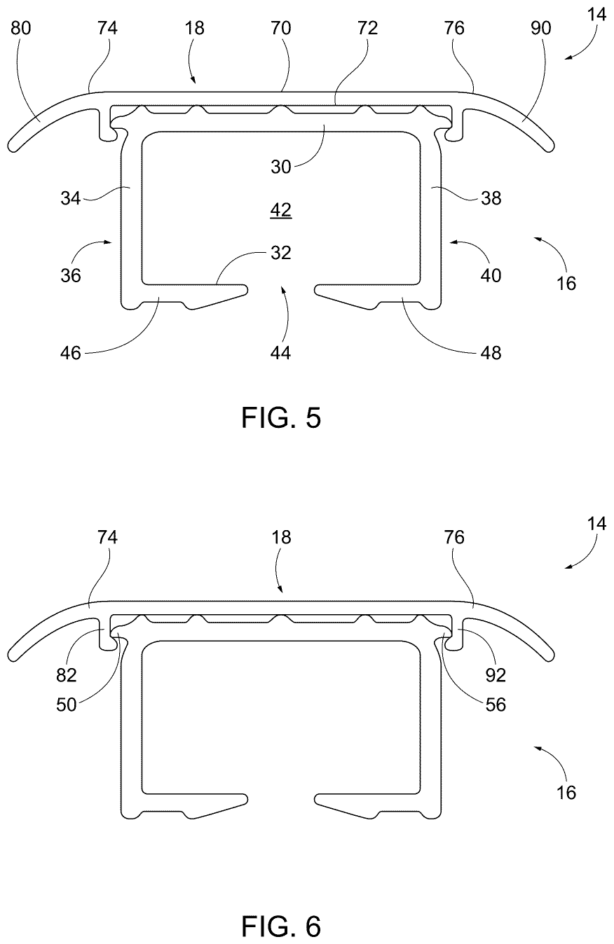

Ends of the first and second flanges 46 and 48 may be spaced from one another to define a slot 44 that extends the length of the retainer 16 such that the retainer 16 generally resembles a u-channel strut. The slot 44 may be configured to slidably engage the groove 28 in each of the plurality of fasteners 20. The first flange 46 and second flange 48 may have a profile that corresponds to the profile of the groove 28 on either side of each of the plurality of fasteners 20. For instance, as illustrated in FIG. 2, the groove 28 may have an angular profile defined by the top surface 27 of the projection 25 and the top flange 24. The ends of first flange 46 and the second flange 48 may have corresponding angular profiles as illustrated in FIG. 5. The corresponding profiles of the groove 28 and the first flange 46 and second flange 48 may ensure that the retainer is installed to the track 12 correctly. It will be appreciated that the groove 28 and the first flange and second flanges 46 and 48 may have alternative matching profiles. The top flange 24 of the fasteners 20 may abut tops of the first flange 46 and second flange 48 and the second end of the fasteners 20 may extend through the slot into the track 12. In an embodiment, the fasteners 20 may be slid into the slot 44 of the retainer 16 allowing alignment of a plurality of fasteners 20 to corresponding openings in the track 20, and then the retainer 16 and fasteners 20 can be pressed into the track 12 to secure the assembly thereto. The top 30, first wall 34, and second wall 38 may be of a consistent thickness to improve the manufacturability of the retainer 16. The retainer may be made of plastic, polymer, composite material, metal (such as an aluminum or titanium alloy), or any other suitable rigid material.

To facilitate coupling the retainer 16 and cover 18, the retainer 16 includes a first catch 50 extending outward from a side of the top 30 and a second catch 56 extending outward from an opposite side of the top 30. The first catch 40 has a ramp 52 and a catch surface 54 on an underside thereof and the second catch 56 has a ramp 58 and a catch surface 60 on an underside thereof. The ramp 52 of the first catch 50 angles downwards from the top 30 of the retainer 16 to the catch surface 54 and the ramp 58 of the second catch 56 angles downwards from the top 30 of the retainer 16 to the catch surface 60. To allow the cover 18 to firmly couple to the retainer 16 along the entire length of the raceway assembly 14, the first catch 50 and second catch 56 extend outwards from the top 30 of the retainer 16 along the entire length of the retainer 16. It will be appreciated that the first catch 50 and the second catch 56 may have evenly spaced gaps such that a plurality of evenly spaced first catches 50 and second catches 56 may extend along the entire length of the retainer 16.

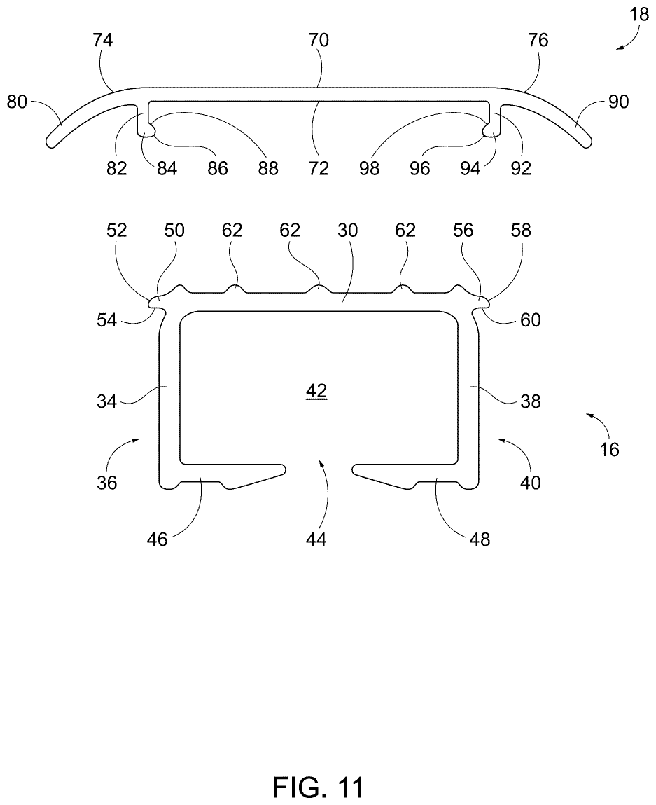

As shown in FIG. 11, the cover 18 has a top surface 70, a bottom surface 72, a first side 74, and a second side 76 opposite the first side 74. A first flap 80 extends outwards from the first side 74 of the cover 18 and curves downwards towards the bottom surface 72 of the cover 18, and a second flap 90 extends outwards from the second side 76 of the cover 18 and curves downwards towards the bottom surface 72 of the cover 18. In an alternative embodiment, the first flap 80 and second flap 90 may extend out horizontally without any downward curve. When the raceway assembly 14 is installed and coupled to the track 12, the cover 18 is substantially at the same height as the surface in which the raceway assembly is recessed. For instance, if the raceway assembly is recessed in the floor of the aircraft, the cover 18 may lay substantially flat with the floor. To keep the surface generally flat when installed, the first flap 80 and second flap 90 may deflect upwards slightly such that the flaps create a generally seamless transition from the surface to the top surface 70 of the cover 18. To allow this deflection, the cover may be made of a resilient material, such as plastic, composite, or other suitable material.

Turning now to FIGS. 5, 6, and 11, to allow the cover 18 to removably couple to retainer 16, the cover 18 additionally includes a first arm 82 extending downwards from the bottom surface 72 of the cover 18 at the first side 74, and a second arm 92 extending downwards from the bottom surface 72 of the cover 18 at the second side 76. The first arm 82 includes a first hook 84 and the second arm 92 includes a second hook 94. The first hook 84 and the second hook 94 extend inward towards each other at the end of the first and second arms respectively. The first hook 84 has a ramp 86 that angles upwards towards a hook surface 88. Similarly, the second hook 94 has a ramp 96 that angles upwards toward a hook surface 98. To provide a secure attachment to the retainer 16, the first and second arms 82 and 92 extend along the length of the cover. It will be appreciated that the first and second arms 82 and 92 may have evenly spaced gaps such that each cover includes a plurality of first and second arms 82 and 92 disposed evenly along the length of the cover 18 for engaging with corresponding catches on the retainer 16.

The cover 18 is removably coupled to the retainer generally by the engagement of the first arm 82 and the first hook 84 of the cover 18 with the first catch 50 of the retainer 16 and the engagement of the second arm 92 and the second hook 94 with the second catch 56. The cover 18 can be coupled to the retainer 16 as illustrated, by a snap fit, or alternatively by a friction fit, a press fit, or with at least one suitable mechanical fastener such as screws, bolts, rivets, etc. To couple the cover 18 to the retainer 16 by snap fit, the first arm 82 of the cover 18 is aligned with the first catch 50 of the retainer 16 and the second arm 92 of the cover is aligned with the second catch 56 of the retainer 16. As downward pressure is applied to the cover 18, the ramp 52 of the first catch 50 engages the ramp 86 of the first hook 84, and the ramp 58 of the second catch 56 engages with the ramp 96 of the second hook 94. The downward pressure and angle of the ramps causes the first and second arm 82 and 92 to deflect outward. Once the cover 18 has been pushed downwards past a point where the ramps can no longer engage each other, the first and second arms 82 and 92 return to their original position. In this position, the hook surface 88 of the first hook 84 is adjacent to the catch surface 54 of the first catch 50 and the hook surface 98 of the second hook 94 is adjacent to the catch surface 60 of the second catch 56. In another embodiment, only the first hook 84 and the second hook 94 will have ramps 86 and 96 respectively. The ramp 86 of the first hook 84 may engage the first catch 50 and the ramp 96 of the second hook 94 may engage the second catch 56 to deflect the first arm 82 and the second arm 92 outward when downward pressure is applied to the cover 18. In another embodiment, only the first catch 50 and the second catch 56 will have ramps 52 and 58 respectively. The ramp 52 of the first catch 50 may engage the first hook 84 and the ramp 58 of the second catch 56 may engage the second catch 56 to deflect the first arm 82 and the second arm 92 outward when downward pressure is applied to the cover 18. The retainer 16 retains the installed cover 18 by the engagement of the hook surface 88 of the first hook 84 with the catch surface 54 of the first catch 50 and the hook surface 98 of the second hook 94 engages the catch surface 60 of the second catch 56.

The cover 18 can be removed from the retainer 16 by deflecting one side of the cover upwards until that side's hook surface does not engage the catch surface, for example when it is desired to replace the cover due to wear without having to replace the wires. The hook surface and the catch surface of the opposing side can then be disengaged and the cover 18 can be removed. To prevent inadvertent removal of the cover 18 by unintended deflection from pressure being applied to the top surface of the cover 18, the retainer 16 has a plurality of ridges 62 that extend upwardly from the top 30 along a length thereof. The plurality of ridges 62 support the bottom surface 72 of the cover 18 when the cover 18 is installed. The ridges thereby prevent the cover 18 from bending or flexing in a manner that would allow the cover to be inadvertently removed when it is installed and pressure is exerted on the top surface 70, for instance if a passenger stepped on the cover 18. It will be appreciated that the cover 18 may alternatively be installed and removed by sliding the cover over the retainer 16.

Although certain embodiments have been shown and described, it is understood that equivalents and modifications falling within the scope of the appended claims will occur to others who are skilled in the art upon the reading and understanding of this specification.

What is claimed is:

1. A track assembly for routing wires in an aircraft, the track assembly comprising:
a retainer configured to be coupled to a track or frame in the aircraft, the retainer having a top, a first wall extending from the top and defining a first side with the top, a second wall extending from the top and defining a second side with the top, a first flange projecting inward from the first wall, and a second flange projecting inward from the second wall, wherein the top, first wall, second wall, first flange, and second flange define a passageway for wires; and
a cover configured to be removably coupled to the retainer.

2. The track assembly according to claim 1, wherein the retainer additionally includes a first catch extending outward from the first side and a second catch extending outward from the second side, and wherein the cover includes a cover having a top surface, a bottom surface, a first arm projecting from the bottom surface and having a first hook for engaging the first catch, and a second arm projecting from the bottom surface and having a second hook for engaging the second catch.

3. The track assembly according to claim 2, wherein the first catch has a first catch ramp that angles downward from the top of the retainer to a first catch surface and the second catch has a second catch ramp that angles downward from the top of the retainer to a second catch surface.

4. The track assembly of claim 3, wherein the first hook has a first hook ramp that angles upward from a bottom of the first arm to a first hook surface and the second hook has a second hook ramp that angles upward from a bottom of the second arm to a second hook surface.

5. The track assembly of claim 2, wherein the first arm and the second arm are configured to deflect outward until the first hook engages the first catch and the second hook engages the second catch when the cover is pressed downward onto the retainer.

6. The track assembly of claim 2, further comprising a first flap extending outward from a first side of the cover and a second flap extending outward from a second side of the cover, wherein the first and second flaps contact a surrounding surface and create a substantially flat surface with the surrounding surface when the track assembly is installed.

7. The track assembly of claim 6, wherein the first flap and the second flap curve downward toward the bottom of the cover.

8. The track assembly of claim 2, wherein the first arm and the second arm extend along a length of the cover and the first wall and second wall extend along a length of the retainer.

9. The track assembly of claim 1, further comprising at least one ridge extending upward from the top of the retainer, wherein the at least one ridge is configured to contact the bottom of the cover when the cover is installed on the retainer.

10. The track assembly of claim 1, wherein the retainer has a substantially rectangular profile and is extruded to a length.

11. The track assembly of claim 1, wherein the cover is made from one of a composite material, polymer, plastic, or aluminum.

12. The track assembly of claim 1, wherein the retainer is made from one of a composite material, polymer, plastic, or aluminum.

13. The track assembly according to claim 1, wherein ends of the first and second projections are spaced from one another to define a slot extending a length of the retainer.

14. The track assembly of claim 13, further comprising a plurality of fasteners configured to couple the retainer to the track or frame, wherein the fasteners are configured to be received in the slot.

15. A track assembly for routing wires in an aircraft, the track assembly comprising:
a retainer configured to be coupled to a track or frame in the aircraft, the retainer having a top, a first wall extending from the top and defining a first side with the top, a second wall extending from the top and defining a second side with the top, a first flange projecting inward from the first wall, a second flange projecting inward from the second wall, a first catch extending outward from the first side, and a second catch extending outward from the second side, wherein the top, first wall, second wall, first flange, and second flange define a passageway for wires; and
a cover having a top surface, a bottom surface, a first arm projecting from the bottom surface and having a first hook for engaging the first catch, and a second arm projecting from the bottom surface and having a second hook for engaging the second catch,
wherein the cover is configured to be removably coupled to the retainer by engagement of the first hook with the first catch and by engagement of the second hook with the second catch.

16. The track assembly according to claim 15, wherein the first catch has a first catch ramp that angles downward from the top of the retainer to a first catch surface and the second catch has a second catch ramp that angles downward from the top of the retainer to a second catch surface.

17. The track assembly of claim 16, wherein the first hook has a first hook ramp that angles upward from a bottom of the first arm to a first hook surface and the second hook has a second hook ramp that angles upward from a bottom of the second arm to a second hook surface.

18. The track assembly of claim 15, wherein the first arm and the second arm are configured to deflect outward until the first hook engages the first catch and the second hook engages the second catch when the cover is pressed downward onto the retainer.

19. The track assembly of claim 15, further comprising a first flap extending outward from a first side of the cover and a second flap extending outward from a second side of the cover, wherein the first and second flaps contact a surrounding surface and create a substantially flat surface with the surrounding surface when the track assembly is installed.

20. A track assembly for routing wires in an aircraft, the track assembly comprising:
a retainer configured to be coupled to a track or frame in the aircraft, the retainer having a first catch extending outward from a first side and a second catch extending outward from a second side; and
a cover having a top surface, a bottom surface, a first arm projecting from the bottom surface and having a first hook for engaging the first catch, and a second arm projecting from the bottom surface and having a second hook for engaging the second catch,
wherein the cover is configured to be removably coupled to the retainer by engagement of the first hook with the first catch and by engagement of the second hook with the second catch.
